(19) United States
(12) Patent Application Publication
(10) Pub. No.: US 2005/0179629 A1
(43) Pub. Date: Aug. 18, 2005

(54) LIGHTING DEVICE AND LIGHTING SYSTEM

(75) Inventor: Takao INOUE, Kawagoe-shi, Saitama (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: PIONEER CORPORATION, Tokyo (JP)

(21) Appl. No.: 10/906,312

(22) Filed: Feb. 14, 2005

(30) Foreign Application Priority Data
Feb. 17, 2004 (JP) 2004-039573

(51) Int. Cl. G02F 1/136

(52) U.S. Cl. 345/82

(57) ABSTRACT

An incremental current of forward current through LEDs (LED1 and LED2) due to power supply voltage rise is shunted by a PNP transistor (Q1), and the forward current value becomes predetermined current value corresponding to rated voltage. Without necessitating constant-current circuit, the LEDs (LED1 and LED2) emit light in desired luminance without being damaged. In a state of forward current value fluctuating due to dispersion of the rated voltage of the LEDs (LED1 and LED2), the current value shunted by the PNP transistor (Q1) varies corresponding to magnitude of voltage drop at a first resistor (R1), and the voltage drop at a third resistor (R3) varies. Based on variation of the voltage drop, potential difference between an emitter of a PNP transistor (Q2) and a base of the PNP transistor (Q1) varies and potential difference between both ends of the LED (LED1 and LED2) varies. Thereby, fluctuation of the forward current value is restrained. Luminance difference among devices can be restrained.

### BACKGROUND OF THE INVENTION

1. Field of the Invention

The present invention relates to a lighting device for turning on a light source and a lighting system using the lighting device.

2. Description of Related Art

Conventionally, for example, in electric equipments such as an audio equipment and air conditioner being installed in a vehicle, a plurality of button switches for setting operation are provided. In order that these button switches can be recognized even in the dark, a lighting system using LEDs (light emitting diodes) being a light source, which is turned on by a lighting device, has been widely utilized. In particular, in a small LCD (liquid crystal display) being used in a mobile phone and the like, a lighting system, in which a plurality of LEDs are in use as a back light being the light source, has been widely utilized.

For example, at the interior decorations of a vehicle, in order that a user can use the vehicle comfortably, many curved surfaces are used. By these curved surfaces, in some cases, the button switches of the electric equipment for the vehicle are disposed along the curved surface. On the other hand, the lighting device is composed of a PCB (printed circuit board) on which electric components have been mounted. By this structure, when the lighting device is used as the light source for the button switches, the distance from the light source to each of the button switches is respectively different, and the illuminance of each of the button switches becomes different. Therefore, it is required that the illuminance of each of the button switches is made equal to one another, by setting the luminance of the plural light sources differently.

Now, for setting the luminance of each of the LEDs differently, for example, a lighting system having a circuit structure shown in FIG. 1 is used. To be more specific, the following circuit structure is adopted. That is, series circuits, in which an LED1 and an LED2 (LED3 and LED4, LED5 and LED6) and a resistor R11 (R12, R13) for setting the luminance of the LEDs are connected in series, are adopted, wherein those series circuits are connected to an input terminal 10, through which electric power is supplied, in parallel.

In the electric power supplied to electric equipments in a vehicle from a battery installed in the vehicle, the difference between the rated voltage value and the maximum voltage value is liable to fluctuate largely, due to the situation that the electric power is supplied to plural electric equipments in the vehicle. Therefore, in each of the electric equipments, for protecting each of circuit elements in the electric equipment, it is required to carry out such settings that each of the circuit elements is not damaged even when the maximum voltage is supplied. For example, in the lighting system having the circuit structure shown in FIG. 1, in order not to give any damage to each of the LEDs 1 to 6, it is required that the current value of the forward current flowing through each of the LEDs 1 to 6 is set corresponding to the maximum voltage pertaining to the electric power to be supplied.

However, for example, in the conventional lighting system having the circuit structure shown in FIG. 1, in case that the electric power is supplied by the rated voltage at the normal time, there is a fear that no sufficient luminance can be obtained due to an insufficient current value of the forward current. Therefore, as shown in FIGS. 2 and 3, it is conceivable that there is provided a constant-voltage circuit for providing a constant voltage in association with the electric power to be supplied.

In the circuit structure shown in FIG. 2, a constant-voltage circuit 11, which supplies the electric power supplied to the input terminal 10 with a constant-voltage being kept, is connected to a series circuit, in which an LED1 and an LED2, and a resistor R11 for setting luminance are connected in series. For instance, between the input terminal 10 and the ground, the collector and the emitter of a transistor Q11 and the above-mentioned series circuit are connected in series. A Zener diode ZD1 is connected between the base of the transistor Q11 and the ground, and a resistor R15 is connected between the base and the emitter of the transistor Q11. If a voltage being higher than the rated voltage has been supplied, the current is to flow to the ground from the resistor R15 via the Zener diode ZD1. Therefore, the base voltage of the transistor Q11 becomes constant, and the forward current value in the LED1 and the LED2 becomes almost constant at the time of overvoltage. Consequently, even on the occasion of overvoltage, the LED1 and the LED2 are turned on normally without any damage.

However, in the circuit structure shown in FIG. 2, in a voltage range in which a voltage of electric power being supplied is higher than its rated voltage, a normal lighting can be obtained. However, when the voltage is lowered, the luminance is decreased gradually at relatively rapid timing. For example, in case that the rated voltage is set to be 10 V, by the static characteristic of the transistor Q11, when the voltage value pertaining to the electric power to be supplied is lowered from about 12 V, the luminance is also lowered. Therefore, in order to prevent the luminance from lowering at the rapid timing at the time of voltage lowering, it is conceivable that the circuit structure shown in FIG. 3 whose characteristic at the time of voltage drop is good is adopted.

In the circuit structure shown in FIG. 3, a differential type constant-voltage circuit 12, which supplies the electric power supplied to the input terminal 10 with a constant-voltage being kept, is connected to a series circuit, in which an LED1 and an LED2, and a resistor R11 for setting luminance are connected. Specifically, between the input terminal 10 and the ground, the emitter and the collector of a transistor Q15 and the above-mentioned series circuit are connected in series. Further, a resistor R51 and a Zener diode ZD2 are connected in series between the input terminal 10 and the ground. Between the base of the transistor Q15 and the ground, the collector and the emitter of a transistor Q16 and a resistor R52 are connected in series. Further, between the base and the emitter of the transistor Q15, a resistor R53 is connected. The base of the transistor Q16 is connected to the connection point of the resistor R51 and the Zener diode ZD2. To the collector of the transistor Q15, the series circuit of the LED1 and the LED2 and the resistor R11, and series resistors R54 and R55 are connected in parallel. Between the connection point of the collector of the transistor Q15 and the resistor R54, and the connection point of the emitter of the transistor Q16 and the resistor R52, the collector and the emitter of a transistor Q17 are connected in series. The base of the transistor Q17 is connected to the connection point of the series resistors R54 and R55. Even when the voltage of the electric power to be supplied to the input terminal 10 should vary, the difference between the input and output voltage values at the transistor Q15 becomes small by virtue of the transistors Q16 and Q17, and the characteristic at the time of voltage lowering becomes normal. That is, when the voltage value of the collector side of the transistor Q15 is set to be, for example, 10 V, even the voltage value of the emitter side of the transistor Q15 is lowered to about 10 V, as the voltage value of the collector side, 10 V can be obtained, and the luminance of the LED1 and the LED2 becomes stable.

However, in the circuit structure shown in FIG. 3, the circuit structure for realizing constant voltage control becomes complicated, and making the device small, and increasing the manufacturability in its manufacturing, and reducing the manufacturing cost pose difficulties. By the difference among the rated voltages occurring in the devices caused by the tolerance of the rated voltages of the LEDs, the voltage between both ends of the resistor R11 for setting luminance, which is connected to the LED1 and the LED2 in series, varies. The current value flowing through the LED1 and the LED2 fluctuates. Thereby, due to the dispersion of the rated voltages of the LED1 and the LED2, there is a fear that the luminance among the lighting systems is different.

As mentioned above, for example, at the conventional lighting system having the circuit structure shown in FIG. 1, there is a fear that sufficient luminance cannot be obtained at the rated voltage. For example, in the lighting system having the circuit structure shown in FIG. 2, in which the constant-voltage circuit 11 is disposed, for coping with the variation of the voltage of the electric power to be supplied, the voltage lowering characteristic of the voltage outputted from the constant-voltage circuit 11 at the time of voltage lowering pertaining to the electric power to be supplied leads to voltage lowering at relatively rapid timing, corresponding to the voltage value decrease of the electric power to be supplied. Consequently, the luminance is decreased at rapid timing, and it is difficult to obtain stable luminance. Further, due to the dispersion of the rated voltages of the LED1 and the LED2, the forward current value in the LEDs becomes different correspondingly, consequently there is a fear that luminance difference occurs among the lighting systems. For example, in the lighting system having the circuit structure shown in FIG. 3, in which the constant-voltage circuit 12 whose voltage-lowering characteristic is good is disposed, its circuit structure becomes complicated. As mentioned above, due to the dispersion of the rated voltages of the LED1 and the LED2, the forward current value in the LEDs becomes different correspondingly, consequently there is a fear that luminance difference occurs among the lighting systems. Further, in the circuit structures shown in FIGS. 2 and 3, the transistor Q11 or Q15 carries out such control that the constant-voltage is obtained from the voltage pertaining to the electric power to be supplied, therefore, the load for the transistor Q11 or Q15 becomes large, and the large size of transistor is required. Consequently, there is a fear that the cost reduction cannot be obtained. Further, due to use of the large-sized transistor Q11 or Q15, there is a fear that collector dissipation becomes large.

### SUMMARY OF THE INVENTION

It is therefore an object of the present invention in view of the forgoing problems to provide a lighting device and a lighting system in which its structure is simple and good performance at the lighting can be obtained.

A lighting device according to an aspect of the present invention includes: a current value setter for setting a forward current value flowing through a light source; a current shunt section for detecting the forward current value based on the voltage drop at the current value setter and providing current shunting for a part of a power supplied corresponding to the magnitude of the forward current value, in parallel with the light source; and a current limiter for controlling a state such that a current flows through the light source corresponding to the magnitude of the current value shunted by the current shunt section.

A lighting system according to another aspect of the present invention includes: the above-mentioned lighting device; and a light source that is turned on by the lighting device with electric power supply.

### BRIEF DESCRIPTION OF THE DRAWINGS

FIG. 1 is a circuit diagram showing a conventional lighting system;

FIG. 2 is a circuit diagram showing a lighting system, upon which the present invention is based;

FIG. 3 is a circuit diagram showing another lighting system, upon which the present invention is based;

FIG. 4 is a circuit diagram showing a schematic structure of a lighting system according to an embodiment of the present invention;

FIG. 5 is a graph showing a relation between a voltage value being applied to LEDs and a current value of the forward current flowing through the LEDs in the above-mentioned embodiment in comparison with that in another circuit configuration;

FIG. 6 is a graph showing a relation between a voltage value being applied to LEDs and a current value of the forward current flowing through the LEDs in the above-mentioned embodiment in comparison with that in another circuit configuration, when the rated voltage of the LEDs has varied;

FIG. 7 is a circuit diagram showing a schematic structure of a lighting system according to another embodiment of the present invention;

FIG. 8 is a circuit diagram showing a schematic structure of a lighting system according to a still another embodiment of the present invention; and

FIG. 9 is a circuit diagram showing a schematic structure of a lighting system according to a further another embodiment of the present invention.

### DETAILED DESCRIPTION OF PREFERRED EMBODIMENTS

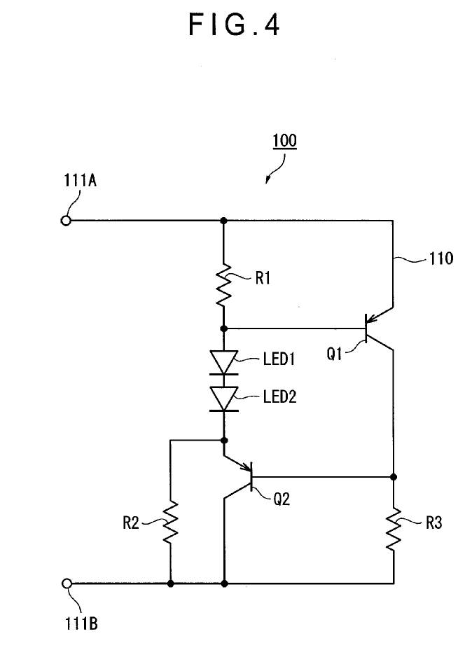

Referring now to the drawings, embodiments of the present invention will be explained. According to the embodiments of the present invention, LEDs are used as a light source. Here, the light source is not limited to the LEDs, and lamps such as electric bulbs can be used as the light source. FIG. 4 is a circuit diagram showing a schematic structure of a lighting system according to an embodiment of the present invention.

(Structure of Lighting System)

In FIG. 4, a reference numeral 100 denotes a lighting system. This lighting system 100 is used as the lighting for knobs and button switches that set the operation at, for example, an audio equipment and an air conditioner being installed in a vehicle, and also used as the back light for a display device such as an LCD in which the operation contents and the set contents and the like are displayed. The lighting system 100 is comprised of a plurality of LEDs, for example, two LED1 and LED2, as the light source, and a lighting device 110 that turns on the LED1 and the LED2. Here, the number of the LEDs 1 and 2 is not limited to two, one LED is possible, and it is also possible that a plurality of LEDs is connected in series. The lighting device 110 is comprised of a pair of input terminals 111A and 111B to which electric power from a battery in a vehicle is supplied based on, for example, the operation that turns on headlights, corresponding to the operation of a switch that turns on the headlights.

Between the pair of input terminals 111A and 111B, a series circuit, in which a first resistor R1 for setting a current value, the LED1 and the LED2 being the light source, and a second resistor R2 are connected in series, is connected in series. Further, between the pair of input terminals 111A and 111B, a series circuit, in which the emitter and the collector of a PNP transistor Q1 and a third resistor R3 are connected in series, is connected to the series circuit of the first resistor R1, the LED1 and the LED2, and the second resistor R2 in parallel. The base of the PNP transistor Q1 is connected to the connection point of the first resistor R1 and the LED 1.

Here, the PNP transistor Q1 detects an incremental current of a forward current flowing through the resistor R1 at the time of increase in the voltage, applied across the input terminals 111A and 111B pertaining to the electric power supplied and provides shunting of the incremental current. That is, in case that a current being higher than a predetermined current value flows, as a voltage being higher than a predetermined rated voltage is applied across the input terminals 111A and 111B, the PNP transistor Q1 is set to be in a state that the incremental current being higher than the predetermined current value is caused to be shunted in parallel with the LED1 and the LED2. Specifically, corresponding to the incremental current based on the rise of the voltage applied across the input terminals 111A and 111B, the voltage drop across both ends of the first resistor R1 becomes large. On the basis of the increase of this voltage drop, the potential difference between the emitter and the base of the PNP transistor Q1 becomes large, and the incremental current being higher than the predetermined current value is made to flow in the emitter and the collector of the PNP transistor Q1, by shunting. Thereby a forward current, by which the LED1 and the LED2 emit light at predetermined luminance, comes to flow.

In the lighting device 110, a series circuit of the emitter and the collector of a PNP transistor Q2 is connected to the second resistor R2 in parallel. The base of the PNP transistor Q2 is connected to the connection point of the collector of the PNP transistor Q1 and the third resistor R3.

The PNP transistor Q2 controls a state such the forward current flows through the LED1 and the LED2, corresponding to the magnitude of the current value shunted by the PNP transistor Q1. That is, the PNP transistor Q2 is set to be configured to control a state of flow in such a manner that the current flowing in the LED1 and the LED2 becomes less, as the current value flowing through the PNP transistor Q1 becomes larger. For this control, the PNP transistor Q2 carries out such control that the potential difference across both ends of the LED1 and the LED2 located between the emitter of the PNP transistor Q2 and the base of the PNP transistor Q1 becomes smaller. Specifically, corresponding to the magnitude of the current value to be shunted at the PNP transistor Q1, the voltage drop across both ends of the third resistor R3 becomes large. Thereby the voltage drop at the third resistor R3 becomes larger, the potential difference between the emitter of the PNP transistor Q2 and the base of the PNP transistor Q1 becomes small, and the current flowing between the emitter and the collector of the PNP transistor Q2 becomes less. Further, the potential difference between both ends of the LED 1 and the LED2 becomes small, and current flowing in the LED1 and the LED2 becomes less.

(Operation of Lighting System)

Next, the operation of the lighting system 100 will be explained.

When a voltage pertaining to the electric power supplied from a battery is applied across the input terminals 111A and 111B, a predetermined voltage is respectively applied to the first resistor R1 and the emitter of the PNP transistor Q1. In case that a current with a predetermined values flows as a rated voltage is applied to the input terminals 111A and 111B from the battery, an current is caused to be suitably shunted into the emitter and the collector of the PNP transistor Q1 such that a predetermined forward current flows through the LED1 and the LED2. Further, a base current flow suitably through the PNP transistor Q2, and a current flow suitably between the emitter and the collector of the PNP transistor Q2. Thereby, the predetermined forward current flows through the LED1 and the LED2, and the LED1 and the LED2 are turned on at predetermined luminance, that is, the LED1 and the LED2 emit light.

On the other hand, in case that a voltage being higher than the rated voltage is applied across the input terminals 111A and 111B, a forward current being higher than the predetermined current value flows through the first resistor R1, the LED1, and the LED2. The voltage drop at the first resistor R1 becomes large corresponding to the incremental current. Thereby the voltage drop becomes large, the potential difference between the emitter and the base of the PNP transistor Q1 becomes large correspondingly, and the incremental current flows via the PNP transistor Q1. Therefore, the current value flowing through the first resistor R1, and the LED1 and the LED2 becomes the forward current value corresponding to the rated voltage, and the LED1 and the LED2 emit light at luminance corresponding to the rated voltage without any damage caused by the overvoltage. Here, in a state that a voltage being applied across the input terminals 111A and 1111B becomes small, a current being lower than a current at the rated voltage flows, and the current value of the forward current flowing through the LED1 and the LED2 also becomes small, and the luminance is lowered.

In case that the dispersion occurs in the rated voltage caused by the tolerance of the LED1 and the LED2, for example, the voltage value becomes a somewhat higher value than the rated voltage value, the voltage drop across both ends of the LED1 and the LED2 becomes large, there occurs a state, in which there is a difficulty in the flowing of the forward current. Due to this difficulty in the flowing of the forward current, the voltage drop at the first resistor R1 becomes small, and the potential difference between the emitter and the base of the PNP transistor Q1 becomes small correspondingly. Consequently, the current value flowing between the emitter and the collector of the PNP transistor Q1 becomes small. Thereby, the current value flowing through the third resistor R3 becomes small, therefore, the voltage drop at the third resistor R3 becomes small. Therefore, as the potential difference between both ends of the LED1 and the LED2 becomes large, the forward current more easily flows. On the other hand, when the LED1 and the LED2, whose voltage value is a somewhat lower than the rated voltage, are mounted, operation is inverted from the above-mentioned operation. When, the potential difference between both ends of the LED1 and the LED2 becomes small, the flowing forward current becomes less.

As mentioned above, by changing the easiness in the flowing of the forward current that flows corresponding to the dispersion of the rated voltage of the LED1 and the LED2, the fluctuation of the current value of the forward current flowing through the LED1 and the LED2 can be restrained. Consequently, the luminance difference caused by the dispersion of the rated voltage can be restrained.

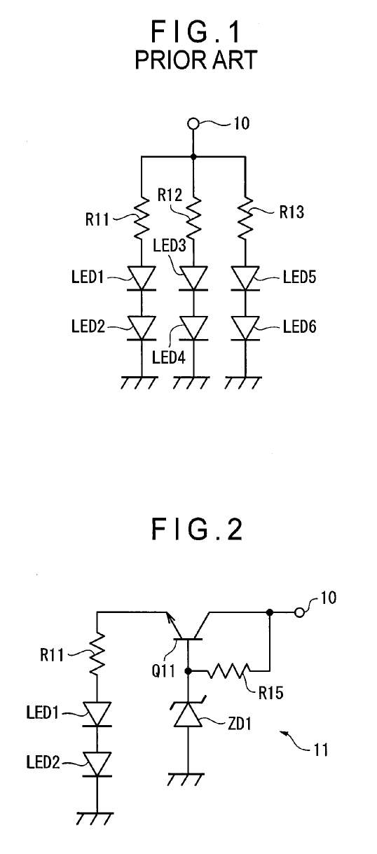

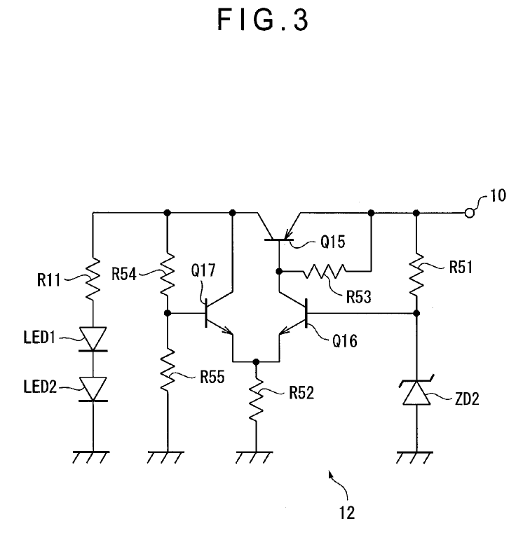

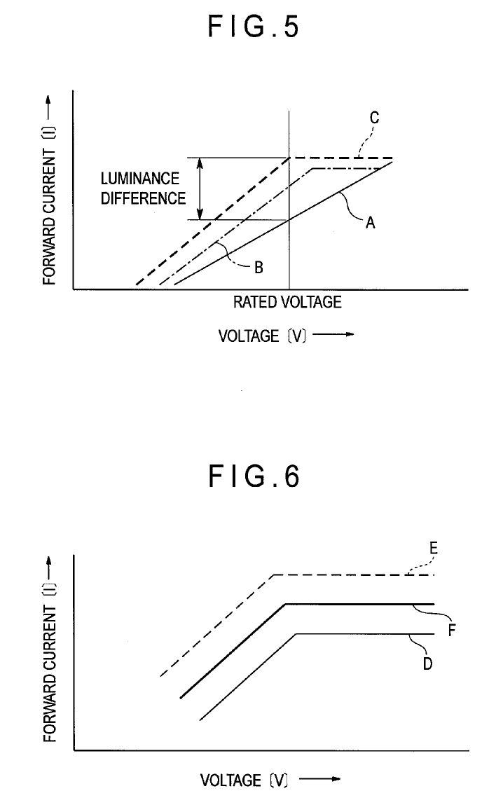

Here, the forward current value in the LED1 and the LED2 will be explained by comparison with comparative examples. FIGS. 5 and 6 are graphs showing a relation between the voltage value being applied to the LED1 and the LED2 and the current value of the forward current flowing through the LED1 and the LED2 in each circuit structure. Here, as the comparative examples, there are used the conventional lighting system having the circuit structure shown in FIG. 1; the lighting system having the circuit structure shown in FIG. 2, upon which the present invention is based; and the lighting system having the circuit structure shown in FIG. 3, upon which the present invention is based.

In the circuit structure of the example shown in FIG. 1, there are used the LED1 and the LED2, whose rated voltage corresponds to the maximum voltage of the power supply voltage from the battery. Therefore, as shown in the thin line A of FIG. 5, in case that the power supply voltage from the battery is the rated voltage, a sufficient forward current cannot flow and sufficient luminance cannot be obtained.

In the circuit structure of the example shown in FIG. 2, in case that a power supply voltage being higher than the rated voltage is applied to, the base voltage of the transistor Q11 becomes constant by the Zener diode ZD1. Therefore, as shown in the alternate long and short dash line B in FIG. 5, at the overvoltage, a forward current corresponding to the rated voltage flows through the series circuit of the resistor R11 and, the LED1 and the LED2, and predetermined luminance can be obtained. However, when the power supply voltage is lowered, the forward current value begins to decrease from the point of a somewhat higher voltage than the rated voltage, and at the rated voltage, the forward current becomes a somewhat lower current value than the value at the time of the overvoltage. That is, the decrease of the luminance occurs at the rapid timing at the time of lowering of voltage.

Further, in the circuit structure of the example shown in FIG. 3, a good characteristic at the time of lowering of voltage can be obtained by the differential type constant-voltage circuit 12. As shown in the dotted line C of FIG. 5, the predetermined forward current value can be obtained even at the position near the rated voltage, and the predetermined luminance can be obtained. On the other hand, in the circuit structure of the embodiment of the present invention shown in FIG. 4, the PNP transistor Q1 recognizes the forward current value corresponding to the magnitude of the power supply voltage, and the current flow is suitably shunted such that the predetermined forward current value can be obtained at the time of the rated voltage. Therefore, like the circuit structure of the example shown in FIG. 3, as shown in the dotted line C of FIG. 5, a stable forward current value can be obtained and the predetermined luminance can be obtained.

Here, in the circuit structure of the comparative example shown in FIG. 3 and the circuit structure of the embodiment of the present invention shown in FIG. 4, there will be examined a case, in which the rated voltage of the LED1 and the LED2 is changed. In the circuit structure of the example shown in FIG. 3, in case that the rated voltage of the LED1 and the LED2 has been changed to a high state, the voltage across both ends of the LED1 and the LED2 is changed, that is, becomes high. Therefore, as shown in the thin line D of FIG. 6, the current value of the forward current is decreased. In the circuit structure of the example shown in FIG. 3, in case that the rated voltage of the LED1 and the LED2 has been changed to a low state, the voltage across both ends of the LED1 and the LED2 becomes low. Therefore, as shown in the dotted line E of FIG. 6, the current value of the forward current is increased.

On the other hand, in the circuit structure of the embodiment of the present invention shown in FIG. 4, in case that the rated voltage of the LED1 and the LED2 has been changed, as mentioned above, even when the current value of the forward current becomes a fluctuating state, corresponding to the change of the rated voltage of the LED1 and the LED2, the voltage drop of the first resistor R1 is changed, and the shunting state at the PNP transistor Q1 is also changed correspondingly. Consequently, the voltage drop of the third resistor R3 is changed correspondingly, the potential difference at both ends of the LED1 and the LED2 becomes large or small correspondingly, and the easiness in the flowing of the current is changed correspondingly. Therefore, even when the rated voltage of the LED1 and the LED2 has been changed, since the easiness in the flowing of the current is changed correspondingly, as shown in the thick line F of FIG. 6, the fluctuation of the forward current value is restrained, and a stable forward current value can be obtained. Therefore, even when the rated voltage of the LED1 and the LED2 has been changed, the luminance difference among devices does not occur, and a lighting system having a good performance can be obtained.

As mentioned above, at the embodiment of the present invention, the PNP transistor Q1 detects the forward current value by the voltage drop at the first resistor R1, which sets the forward current value flowing through the LED1 and the LED2. A part of electric power to be supplied is shunted in parallel with the light emitting diode LED1 and the LED2, corresponding to the magnitude of this detected forward current value. Thereby for example, without using a constant-current circuit at the power supply voltage applied across the input terminals 111A and 111B, the forward current value in the LED1 and the LED2 becomes constant, and predetermined luminance can be obtained, so that there is no need any more for e.g. a constant-current circuit being forced to be large-sized to adjust the dispersion of the FETs (field effect transistors) being switching elements constituting the constant-current circuit. Thus there is facilitated the simplification of the circuit structure. Corresponding to the magnitude of the current value being shunted at the PNP transistor Q1, the PNP transistor Q2 controls the easiness in the flowing of the forward current at the LED1 and the LED2. Therefore, even at a state, in which the current value of the forward current fluctuates due to the dispersion of the rated voltage of the LED1 and the LED2, the easiness in the flowing of the forward current is changed corresponding to the forward current value being detected at the PNP transistor Q1, therefore, the fluctuation of the forward current value can be restrained, and a stable forward current value can be obtained. Therefore, the occurrence of the luminance difference among devices due to the change of the rated voltage can be prevented, and the lighting system 100 having stable luminance and good performance can be provided.

The lighting system 100 is provided with a construction for turning on the LED1 and the LED2. Therefore, the lighting system 100 can be made as a small lighting system that is made on the same PCB of the lighting device 110. For example, the lighting system 100 can be used suitably for relatively small electric equipments such as a lighting system for button switches and a backlight for an LCD. Further, without using a constant-current circuit for the power source of the small electric equipment, the lighting system 100, which can obtain a stable forward current value and stable luminance, can be provided, therefore, it becomes easy that the electric equipments are small sized.

For setting the forward current value of the LED1 and the LED2, the first resistor R1 is connected to the LED1 and the LED2 in series. Therefore, the setting of the forward current value to set the luminance of the LED1 and LED2 can be obtained in a simple structure. Further, a structure detecting the current value of the forward current flowing through the LED1 and the LED2 can be obtained easily. That is, the fluctuation of the forward current value can be detected easily based upon the voltage drop, and the circuit structure for obtaining a stable forward current value at the LED1 and the LED2 can be simplified easily. Increasing the manufacturability, making the lighting system 100 small and light, and reducing the cost can be accomplished easily.

Further, as a structure, in which the forward current value is detected and is made to be suitably shunted, the PNP transistor Q1 is used. That is, the base of the PNP transistor Q1 is connected to the connection point of the first resistor R1 and the LED1, and the series circuit of the emitter and the collector of the PNP transistor Q1 are connected to the series circuit of the first resistor R1, and the LED1 and the LED2, in parallel. Therefore, by a simple structure, in which one PNP transistor being a switching element is disposed, it can be easily realized to detect the forward current value and to enable the current to be shunted. Increasing the manufacturability, making the lighting system 100 small and light, and reducing the cost can be realized easily.

As a structure, in which the easiness in the flowing of the forward current in the LED1 and the LED2 is controlled corresponding to the magnitude of the current value being made to be shunted by the PNP transistor Q1, the PNP transistor Q2 is disposed. That is, the PNP transistor Q2 controls a state such that the forward current flowing in the LED1 and the LED2 becomes less corresponding to the magnitude, becoming greater, of the current value being made to be shunted by the PNP transistor Q1. With this control, by utilizing the operation of the PNP transistor Q1, which makes the predetermined forward current value flow in the LED1 and the LED2 by causing an excessive amount of the over-current to be shunted, there can be realized easily the control, in which the fluctuation of the forward current value corresponding to the dispersion of the rated voltage of the LED1 and the LED2 is restrained. That is, as mentioned above, corresponding to a state, in which the forward current value becomes larger or smaller due to the dispersion of the rated voltage of the LED1 and the LED2, it is enough that control making the potential difference of both ends of the LED1 and the LED2 smaller or larger executed. Thereby, the change of the easiness in the flowing of the forward current can be executed easily, and this control can be realized by a simple structure using the PNP transistor Q2 being the switching element, and increasing the manufacturability, making the lighting system 100 small and light, and reducing the cost can be realized easily.

Further, as a structure, in which the easiness in the flowing of the forward current is controlled corresponding to the magnitude, becoming greater, of the current that is made to be shunted at the PNP transistor Q1, the potential difference between both ends of the LED1 and the LED2 is controlled to be smaller corresponding to the magnitude of the current being made to be shunted. Therefore, as mentioned above, a structure, in which the easiness in the flowing of the forward current is controlled by the simple structure using the PNP transistor Q2 being the switching element, can be obtained easily. Thus it is made possible with ease to increase the manufacturability, make the lighting system 100 small and light, and reduce the cost.

Furthermore, as a structure, in which the forward current value is controlled, the PNP transistor Q2 is used. That is, the series circuit of the emitter and the collector of the PNP transistor Q2 is connected to the LED2 in series, and the base of the PNP transistor Q2 is connected to the collector of the PNP transistor Q1 being an output terminal, from which the current shunted by the PNP transistor Q1 is outputted. Therefore, by a simple structure, in which one PNP transistor Q2 being a switching element is disposed, a circuit structure that can supply a stable forward current can be easily realized. Increasing the manufacturability, making the lighting system 100 small and light, and reducing the cost can be realized easily.

Still further as a structure, in which the fluctuation of the forward current value due to the dispersion of the rated voltage of the LED1 and the LED2 is restrained, the third resistor R3 is connected between the collector and the base of the PNP transistor Q2. That is, the voltage drop is changed corresponding to the magnitude of the current value being shunted by the PNP transistor Q1. Therefore, corresponding to a state, in which the forward current value fluctuates due to the dispersion of the rated voltage, the potential difference between both ends of the LED1 and the LED2 is changed, and the easiness in the flowing of the current is changed in a state such that the fluctuation of the forward current value due to the dispersion of the rated voltage is absorbed. With this simple structure, the control can be realized easily. Consequently, increasing the manufacturability, making the lighting system 100 small and light, and reducing the cost can be realized easily.

The second resistor R2 is connected to the series circuit of the emitter and the collector of the PNP transistor Q2 in parallel. Therefore, the current flowing through the PNP transistor Q2 for preventing the fluctuation of the forward current due to the dispersion of the rated voltage of the LED1 and the LED2 flows through the second resistor R2 in a state of the current being bypassed. Consequently, the current value flowing through the PNP transistor Q2 can be reduced, and the collector dissipation at the PNP transistor Q2 can be decreased. Effective lighting by the electric power to be supplied can be realized by the simple circuit structure.

### Modifications of Embodiment

The present invention is not limited to the above-mentioned embodiment, and without departing from the scope and spirit of the present invention, the following modifications can be incorporated.

That is, as mentioned above, the present invention is utilized for the lighting for knobs and button switches that set the operation at an audio equipment and an air conditioner being installed in a vehicle, and also utilized for the back light of a display device in the vehicle. Further, the present invention can be also utilized for any lighting system for other equipments, besides the equipments in a vehicle. And, as the light source, any lamp such as an electric bulb can be used, in addition to the LED1 and the LED2. Thereby, it is enough that the light source is selected in conformity with the lighting conditions, and in addition to the lighting for knobs and button switches and the back light of the display device, the lighting system 100 can be utilized for any lighting system. The lighting system 100 can be constructed such that the light source is detachable, whereby the lighting device 110 can be utilized for some other purpose by changing the light source. Further, as mentioned above, the number of the LEDs is not limited to two, only one LED can be used, and also a plurality of LEDs can be used.

The present invention can be applied to electric power from a power source having a constant-current circuit, in addition to the power source that does not have the constant-current circuit.

Also, for setting the forward current value flowing through the LED1 and the LED2, the first resistor R1 is connected to the LED1 and the LED2 in series. However, any structure, in which the current value flowing through the light source can be set suitably, can be used. Further, a variable resistor that can change its resistance value can be used. At a structure using this variable resistor, the adjustment for setting the forward current value flowing through the light source, to which the variable resistor is connected, for example, in series, becomes easy, and increasing the manufacturability and increasing the versatility can be realized.

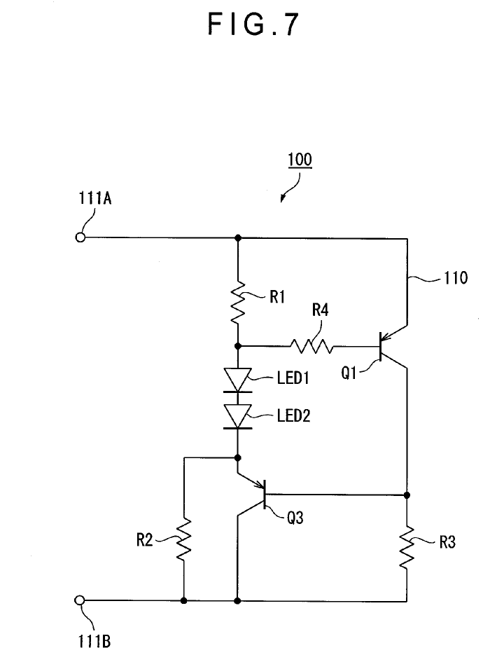

As a current shunt section, the structure having the PNP transistor Q1 has been explained, however, the structure is not limited to the structure having a transistor being a switching element, any structure, which provides shunting corresponding to the forward current, can be used, for example, by using a thyristor. Further, for example, as shown in FIG. 7, a resistor R4 can be disposed between the base of the PNP transistor Q1 and the connection point of the first resistor R1 and the LED1. With this structure, the constant-current characteristic of the current, which is shunted by the PNP transistor Q1 corresponding to the change of the power supply voltage being applied to the input terminals 111A and 111B, can be changed by the fact that the resistance value of the resistor R4 is set suitably. Therefore, corresponding to the variation of the forward current value based on the change of the power supply voltage the current value to be shunted can be changed, and the luminance of the LED1 and the LED2 can be changed suitably. Further, by making the resistor R4 a variable resistor, the change of luminance corresponding to the change of the power supply voltage can be set easily by changing the resistance value of this variable resistor suitably.

As a structure using a plurality of LEDs, the structure is not limited to the structure shown in FIGS. 4 and 7, in which the LEDs are connected in series, and the LEDs can be connected in parallel. To be more specific, for example, between the input terminals 111A and 111B, a plurality of the circuit structures of the lighting system 100 shown in FIGS. 4 and 7 can be connected in parallel. At this structure, in which a plurality of the circuit structures of the lighting system 100 shown in FIGS. 4 and 7 is connected in parallel, for example, the luminance of the LEDs can be easily set differently by changing the resistance value of the first resistor R1. Thereby, the lighting system 100, in which the illuminance is different partially, can be designed easily, and the versatility can be increased.

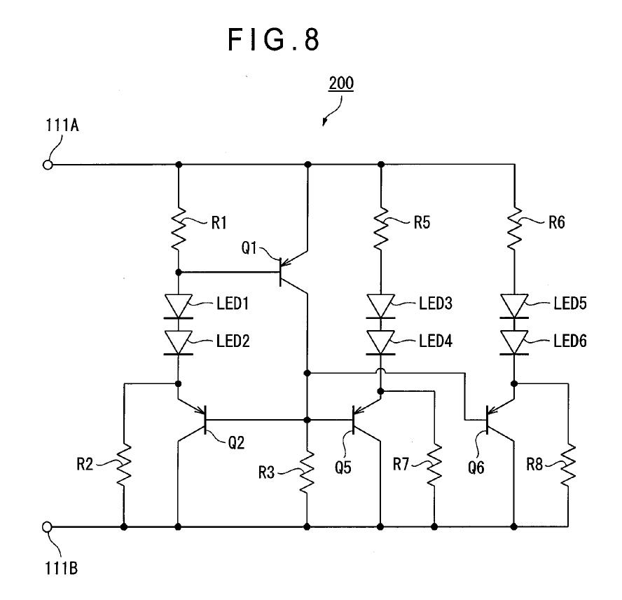

Further, as a circuit structure, in which a plurality of LEDs is connected in parallel, for example, a circuit structure shown in FIG. 8 can be used. That is, at a lighting system 200 shown in FIG. 8, between the input terminals 111A and 111B, to the series circuit of the first resistor R1, the LED1 and the LED2, and the emitter and the collector of the PNP transistor Q2 within the lighting system 100 shown in FIG. 4, a plurality of the series circuits, for example, two series circuits of a first resistor R5 (R6) for setting the forward current value, LED3 and LED4 (LED5 and LED6), and the emitter and the collector of a PNP transistor Q5 (Q6) are connected in parallel. The base of the PNP transistor Q5 (Q6) is connected to the connection point of the collector of the PNP transistor Q1 and the third resistor R3. Further, to the series circuit of the emitter and the collector of the PNP transistor Q5 (Q6), a second resistor R7 (R8) for a bypass is connected in parallel.

In the circuit structure shown in FIG. 8, the luminance of each series of the LED1 and the LED2, the LED3 and the LED4, and the LED5 and the LED6 can be easily set differently. Further, corresponding to each of the series circuits of the first resistor R5 (R6), the LED3 and the LED4 (LED5 and LED6), and the emitter and the collector of the PNP transistor Q5 (Q6), a switching element corresponding to the PNP transistor Q1 for detecting the forward current value is not disposed. Therefore, when the circuit structure is compared with the circuit structure disposing a plurality of the circuits shown in FIG. 4 or 7 in parallel, this circuit structure can be simple. Here, in the circuit structure shown in FIG. 8, a switching element corresponding to the PNP transistor Q1 is not disposed for the LED3 to the LED6. Therefore, in case that the dispersion of the rated voltages of the LED3 to the LED6 occurs, control for restraining the fluctuation of the forward current value is not executed, and there is a fear that the dispersion of the luminance at the LED 3 to the LED6 occurs. Therefore, in case that the dispersion of the luminance is to be prevented, it is desirable that a plurality of the circuits shown in FIG. 4 or FIG. 7 are used in parallel.

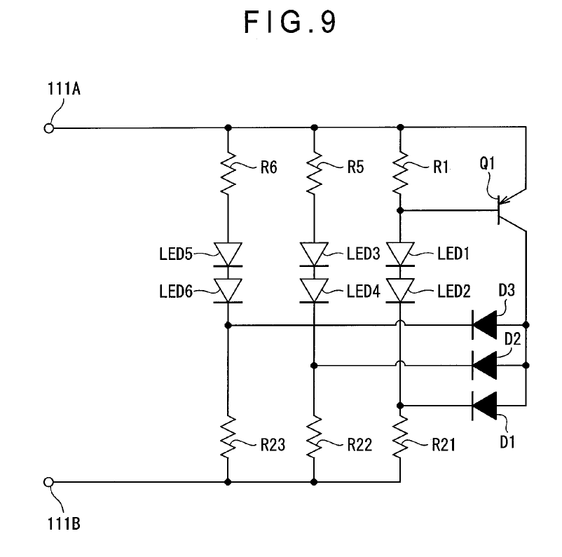

Further, as a structure, in which the dispersion of the luminance caused due to the dispersion of the rated voltage of the LED1 and the LED2 is prevented, the PNP transistor Q2 is used. However, preventing the dispersion of the luminance is not limited to this structure. Any structure, in which the forward current flowing through the LED1 and the LED2 is controlled corresponding to the magnitude of a current shunted in parallel with the LED1 and the LED2, can be used. For example, as the switching element, a thyristor can be used instead of the PNP transistor Q2. Further, for example, as shown in FIG. 9, as a structure, in which the potential difference between both ends of the LED1 and the LED2 is changed, a resistor for control R21 (R22, R23), which changes the potential difference by the change of the voltage drop corresponding to the current value, can be used.

Specifically, as shown in FIG. 9, in the lighting system 200, between the input terminals 111A and 111B, a series circuit of the first resistor R1, the LED1 and the LED2, and the resistor for control R21 is connected in series. Between the input terminals 111A and 111B, to this above-mentioned series circuit, a plurality of series circuits, for example, two series circuits of the first resistor R5 (R6) for setting the forward current value, the LED3 and the LED4 (LED5 and LED6), and the resistor for control R22 (R23) are connected in parallel. Further, to the series circuit of the first resistor R1, and the LED1 and the LED2, a series circuit of the emitter and the collector of the PNP transistor Q1 and the anode and the cathode of a diode D1 for preventing a reverse current are connected in parallel. Between the connection point of the collector of the PNP transistor Q1 and the anode of the diode D1, and the connection point of the LED4 and the resistor for control R22, the anode and the cathode of a diode D2 for preventing a reverse current is connected. Further, between the connection point of the collector of the PNP transistor Q1 and the anode of the diode D1, and the connection point of the LED6 and the resistor for control R23, the anode and the cathode of a diode D3 for blocking a reverse current is connected.

In the circuit structure shown in FIG. 9, when the forward current value is increased by the rise of the power supply voltage, as explained regarding the embodiment shown in FIG. 4, the incremental current of the forward current value is shunted via the PNP transistor Q1 and the diodes D1, D2, and D3. The forward current value of the LED1 and the LED2 (LED3 and LED4, LED5 and LED6) becomes the forward current value corresponding to the rated voltage from the battery, and the LEDs emit light without being subjected to any damage. In case that the forward current value fluctuates due to the dispersion of the rated voltage of the LED1 and the LED2, as mentioned above, the potential difference between both ends of the LED1 and the LED2 is changed and the easiness in the flowing of the forward current is changed, and the fluctuation of the forward current value is restrained. That is, in the state that the rated voltage of the LED1 and the LED2 becomes high, the forward current value becomes small. Therefore, the voltage drop at the first resistor R1 becomes small, and the current value shunted by the PNP transistor Q1 becomes also small. Consequently, the current value flowing through the resistor for control R21 being the sum of the forward current value and the current value shunted by the PNP transistor Q1 becomes small, and the voltage drop at the resistor for control R21 becomes small. Therefore, the potential difference between both ends of the LED1 and the LED2 becomes large, and the current becomes easy of flowing. On the contrary, in a state that the rated voltage becomes low, the potential difference between both ends of the LED1 and the LED2 becomes small, and the flowing current becomes less. Therefore, even when the forward current value is changed largely or small depending upon whether the rated voltage is dispersed largely or small, the forward current comes into a state being easy to flow or difficult of flow. Like the above-mentioned embodiment, the fluctuation of the forward current is restrained, and the dispersion of the luminance can be prevented. The circuit structure shown in FIG. 9 is a simple circuit structure, in which the diode D1 and the resistor for control R22 are disposed, therefore, when the circuit structure is compared with a structure using the PNP transistor Q2, the circuit can be disposed at low cost.

Here, in the circuit structure shown in FIG. 9, the power consumption at the resistor for control R21 is larger than that at the structure using the PNP transistor Q2. Therefore, in case that effective lighting is required, it is desirable to use the circuit structure using the PNP transistor Q2. In the circuit structure shown in FIG. 9, the structure, in which the LED3 and the LED4 (LED5 and LED6) are disposed in parallel, is used. However, it is also possible that that there is made no provision of those series circuits and the diodes D2, D3. Further, as a reverse blocking section which is configured to block a reverse current opposed to the forward current, the reverse blocking section is not limited to the diode D1 (D2, D3), and any other device having a reverse blocking function can also be employed.

In order to prevent the collector dissipation, the second resistor R2 (R7, R8) is disposed for a bypass, however, the structure for the bypass is not limited to the resistor, any structure can be used. Further, it is possible that the structure for the bypass is not disposed.

The actual structure and procedures for executing the present invention can be suitably changed to other structure and procedures within the scope and spirit that can achieve the present invention.

### Effects of Embodiments of the Present Embodiment

As mentioned above, the PNP transistor Q1 detects the forward current value on the basis of the voltage drop at the first resistor R1, which sets the forward current value flowing through the LED1 and the LED2. A part of electric power to be supplied corresponding to the magnitude of this forward current value is caused to be shunted in parallel with the LED1 and the LED2, whereupon the PNP transistor Q2 controls the easiness in the flowing of the forward current at the LED1 and the LED2 corresponding to the magnitude of the pertinent current shunted. Therefore, by shunting the incremental current of the forward current value a predetermined forward current is enabled to flow through the LED1 and the LED2. Without using a constant-current circuit, the LED1 and the LED2 can emit light in high performance by using a simple circuit structure, without undergoing any damage at the LED1 and the LED2. Even when the forward current value fluctuates due to the dispersion of the rated voltage of the LED1 and the LED2, the easiness in the flowing of the forward current is changed corresponding to the detected forward current value, and the fluctuation of the forward current can be restrained. The stable forward current can be obtained, and good lighting can be obtained by preventing the luminance difference.

The priority application Number JP 2004-039573 upon which this patent application is based is hereby incorporated by reference.

1. A lighting device, comprising:
a current value setter for setting a forward current value flowing through a light source;
a current shunt section for detecting the forward current value based on the voltage drop at the current value setter and providing current shunting for a part of a power supplied corresponding to the magnitude of the forward current value, in parallel with the light source; and
a current limiter for controlling a state such that a current flows through the light source corresponding to the magnitude of the current value shunted by the current shunt section.

2. The lighting device according to claim 1, wherein the light source is a light emitting diode.

3. The lighting device according to claim 1, wherein the current value setter is a resistor connected to the light source in series.

4. The lighting device according to claim 3, wherein the current shunt section, comprising:
a PNP transistor of which base is connected to the connection point of the current value setter and the light source, and of which series circuit of an emitter and a collector is connected to a series circuit of the current value setter and the light source in parallel.

5. The lighting device according to claim 4, wherein the current shunt section, further comprising:
a resistor connected between the base of the PNP transistor and the connection point of the current value setter and the light source.

6. The lighting device according to claim 1, wherein the current limiter performs a control to have a state such that the current becomes more difficult to flow through the light source as the magnitude of the current value flowing through the current shunt section becomes greater.

7. The lighting device according to claim 6, wherein the current limiter performs a control to reduce the potential difference between both ends of the light source corresponding to the magnitude of the current value flowing through the current shunt section.

8. The lighting device according to claim 1, wherein the current limiter, comprising:
a PNP transistor of which series circuit of an emitter and a collector is connected to the light source in series, and of which base is connected to an output terminal for outputting the current to be shunted by the current shunt section therefrom.

9. The lighting device according to claim 4, wherein the current limiter, further comprising:
a PNP transistor of which series circuit of an emitter and a collector is connected to the light source in series, and of which base is connected to the collector of the PNP transistor of the current shunt section.

10. The lighting device according to claim 8, wherein the current limiter, further comprising:
a resistor connected between the collector and the base of the PNP transistor.

11. The lighting device according claim 8, wherein the current limiter, further comprising:
a resistor that is connected in parallel with the series circuit of the emitter and the collector of the PNP transistor.

12. The lighting device according to claim 1, wherein the current limiter, further comprising:
a resistor connected to the light source in series, and of which voltage drop at both ends becomes large corresponding to the magnitude of the current value being the sum of the forward current value and the current value shunted by the current shunt section.

13. The lighting device according to claim 12, wherein the current limiter comprises a reverse blocking section for blocking a reverse current to the current shunt section while providing to the resistor a flow of current shunted by the current shunt section.

14. The lighting device according to claim 13, wherein the reverse blocking section is a diode.

15. A lighting system, comprising:
a lighting device according to claim 1; and
a light source that is turned on by the lighting device with electric power supply.
